(19) United States
(12) Patent Application Publication
(10) Pub. No.: US 2012/0070632 A1
(43) Pub. Date: Mar. 22, 2012

(54) METHOD OF TRANSFER TO A SHEET, TRANSFER APPARATUS, AND SHEET PRODUCT

(75) Inventor: Hiroharu Sugiyama, Toda-shi (JP)

(73) Assignee: TOTSUYA ECHO CO., LTD., Toda-shi, Saitama (JP)

(21) Appl. No.: 13/319,245

(22) PCT Filed: Apr. 7, 2010
(86) PCT No.: PCT/JP2010/056630

§ 371 Date: Nov. 7, 2011

(30) Foreign Application Priority Data
May 8, 2009 (JP) 2009-113122
Oct. 26, 2009 (JP) 2009-245381

(51) Int. Cl. B44C 1/17; B32B 37/02; B32B 27/00

(52) U.S. Cl. 428/195.1; 156/64; 156/378

(57) ABSTRACT

Provided is transfer method to a sheet, a transfer apparatus and a sheet product capable of transferring a same pattern or design or the like to the same position on a base sheet of various printed materials and the like.

The transfer method of the present invention comprises the steps of (A) coating a thermoplastic resin coating material on a base sheet, (B) supporting and conveying the base sheet coated with the thermoplastic resin coating material by gripping an end of the base sheet with a claw portion provided on a conveyor roll, (C) providing a step wherein a position of the claw portion of the conveyor roll is sensed and a transfer roll having adhered and affixed to its outer peripheral surface a film to which any of a mirror finish, a matt finish or a hologram finish has been previously applied is press contacted on the conveyor roll under a condition in which the transfer roll is heated to at least a temperature at which the thermoplastic resin coating material melts, and (D) peeling the base sheet from the transfer roll, and cooling.

### TECHNICAL FIELD

The present invention relates to a transfer method to a sheet, a transfer apparatus and a sheet product capable of transferring a same pattern or design or the like to the same position on a base sheet of various printed materials and the like.

### BACKGROUND ART

As a conventional method for applying a pattern or design or the like to various printed materials by applying a mirror finish, a matt finish or a hologram finish or the like to the obverse surface, reverse surface or both surfaces of various printed materials, there is known a method of applying a mirror finish, a matt finish or a hologram finish or the like to the outer peripheral surface of a roll and transferring the pattern or design on the roll surface by applying pressure to the roll.

This transfer method uses an engraved roll or block made of a metal plate or the like involving the preparation of a transfer plate called an etching plate or master plate in a series of manufacturing steps that involves enormous expense and time.

So in recent years, a method was discovered that instead of applying a mirror finish, a matt finish or a hologram finish pattern or design to the roll itself, uses a film (elongated format) on the surface layer of which a mirror finish, a matt finish or a hologram finish or the like is used to form a pattern or design using a thermoplastic resin coating material or ultraviolet curable resin coating material or the like. That is, a simple method of effecting transfer was discovered in which the film is wound around the outer peripheral surface of the roll, the surface which is to receive the transfer is previously coated with a thermoplastic resin coating material or an ultraviolet curable resin coating material or the like, and in a dry or uncured state, the surface of the film pattern or design to be transferred is press contacted on the coated surface of the transfer item on the conveyor roll or conveyor belt under conditions in which heat or ultraviolet radiation is applied, following which the film is removed from the various printed materials by rolling it off or rotating it or other such method. As in this method film (elongated format) is used as the plate (transfer film), it is possible to transfer other patterns and designs to various roll format (elongated format) or sheet format printed materials merely by changing the film (elongated format) wound around the outer peripheral surface of the roll.

However, the various printed materials thus produced using a roll format (elongated format) transfer process almost never end up as a roll format (elongated format) finished product after undergoing various printing and paper surface processing. Most commonly, in the various types of printing and paper processing or as a finished product, they are cut into sheets (sheet format) for use, and due to problems arising from the dimensions and positions of the patterns and designs formed on the film surface, it has been difficult to accurately transfer patterns and designs to a prescribed position sheet by sheet.

Also, as described in the foregoing with respect to the roll format (elongated format), if continuous pressed contact transfer processing of the film (elongated format) is followed by methodical cutting into sheets (sheet format) in accordance with the dimensions from the starting point to the finishing point of each individual pattern or design or pluralities thereof formed in the direction in which the film is wound, the same pattern or design will be formed accurately at the same position on each sheet. It is also possible to obtain sheets (sheet format) on which prescribed patterns and designs have been transferred to a prescribed position that match the dimensions of the various types of printing and paper surface processing, or finished product, by manufacturing the patterns and designs specially for the film surface.

However, as described in the foregoing, a roll format (elongated format) to which transfer processing has been applied is almost never printed or surface processed, or forms a finished product, as-is, and also, manufacturing patterns and designs to specifically match the desired sheet dimensions requires enormous expense and time. Accordingly, film manufacturers mostly carry out transfer processing using commercial film which has been previously surface-processed with individual or plural series of patterns and designs. When rolls (elongated format) produced using such film (elongated format) for the transfer process are cut into sheets by the above-described means so that a prescribed pattern or design is positioned at a prescribed location, in some cases the margins are smaller or larger than required, making the sheets unusable for the desired type of printing, paper surface process or finished product. Considering the costs involved, this places constraints on the required dimensions of the various types of printing, paper surface processing and finished products, with respect to the film patterns and designs.

Following sheet cutting by each of the above methods, it was necessary to carry out a process called square cutting that forms a uniform standard for positional alignment between the steps of the various types of printing and paper surface processing, up to the finished product. At this process point, there was a risk of discrepancies arising in the positions of patterns and designs from sheet to sheet.

Also, sheets manufactured by the above-described type of means had little industrial usability.

Moreover, in the case of the transfer processing of various sheet format printed materials, as described above, manufacturers market film having mirror, matt or hologram patterns or designs, with many hologram products in particular manufactured by overseas manufacturers being distributed in the domestic market, in many cases they did not match the dimensions of the existing sheets being sold in Japan by paper manufacturers used in the above-described transfer method, various types of printing and paper surface processing and finished products, and manufacturing patterns and designs specifically to match the desired sheet dimensions, as in the case of the roll format (elongated format), requires enormous expense and time.

Thus, existing sheets were cut to match the dimensions of the film's patterns and designs, and for special dimensions sheets were selected and matched to the dimensions of the film's patterns and designs. Although sensors and the like were used in an attempt to synchronize the alignment of sheets and films, in many cases the patterns and designs did not match, especially in the case of matt or a hologram patterns and designs.

In the absence of a solution to such problems, there was a strong market demand for such a solution that would enable the simultaneous transfer of individual and plural series of mirror, matt or hologram patterns and designs, and of prescribed patterns and designs, and composite patterns and designs, to prescribed positions on each of a plurality of sheets.

Thus, an object of the present inventors is to propose a method for transfer to a sheet that enables the same patterns or designs and the like to be transferred to the same positions on a base sheet of various printed materials and the like.

### DISCLOSURE OF THE INVENTION

The present inventors thought that the discrepancies that arose in the operation of transferring the transfer roll pattern or design onto the base sheet was caused by the timing at which the base sheet was conveyed not being precisely the same as the timing of the rotation of the transfer roll.

The present invention was proposed in view of the above, and relates to a transfer method comprising the steps of (A) coating a thermoplastic resin coating material on a base sheet, (B) supporting and conveying the base sheet coated with the thermoplastic resin coating material by gripping an end of the base sheet with a claw portion provided on a conveyor roll, (C) providing a step wherein a position of the claw portion of the conveyor roll is sensed and a transfer roll having adhered and affixed to its outer peripheral surface a film to which any of a mirror finish, a matt finish or a hologram finish has been previously applied is press contacted on the conveyor roll under a condition in which the transfer roll is heated to at least a temperature at which the thermoplastic resin coating material melts, and (D) peeling the base sheet from the transfer roll, and cooling.

The present invention also proposes the transfer method wherein the film to which any of a mirror finish, a matt finish or a hologram finish has been applied is adhered and affixed over all or part of the outer peripheral surface of the transfer roll, or is adhered and affixed in layers over all or part of the outer peripheral surface.

The present invention also proposes the transfer method comprising the steps of (A) coating a thermoplastic resin coating material on a base sheet, (B) supporting and conveying the base sheet coated with the thermoplastic resin coating material by gripping an end of the base sheet with a claw portion provided on a conveyor roll, (C′) providing a step wherein a position of the claw portion on the conveyor roll is sensed and a transfer roll having any of a mirror finish, a matt finish or a hologram finish applied previously to its outer peripheral surface by an ultraviolet curable resin coating material is press contacted on the conveyor roll under a condition in which the transfer roll is heated to at least a temperature at which the thermoplastic resin coating material melts, and (D) peeling the base sheet from the transfer roll and cooling.

The present invention also proposes the transfer method wherein any of the mirror finish, a matt finish or a hologram finish formed by an ultraviolet curable resin coating material is formed over all or part of the outer peripheral surface of the transfer roll, or is formed in layers over all or part of the outer peripheral surface.

The present invention also proposes the transfer method wherein the thermoplastic resin coating material coated on a base sheet is brought in a preheated state into close adherence with the transfer roll.

The present invention also proposes a transfer method comprising (a) a mechanism for coating a thermoplastic resin coating material on a base sheet, (b) a mechanism for supporting and conveying the base sheet coated with the thermoplastic resin coating material by gripping an end of the base sheet with a claw portion provided on a conveyor roll, (c1) a mechanism for sensing a position of the claw portion on the conveyor roll and press contacting on the conveyor roll a transfer roll having adhered and affixed to its outer peripheral surface a film to which any of a mirror finish, a matt finish or a hologram finish has been previously applied, (c2) a mechanism for heating the transfer roll to at least a temperature at which the thermoplastic resin coating material melts, (d1) a mechanism for peeling the base sheet from the transfer roll, and (d2) a mechanism for cooling the base sheet.

The present invention also proposes the transfer method comprising (a) a mechanism for coating a thermoplastic resin coating material on a base sheet, (b) a mechanism for supporting and conveying the base sheet coated with the thermoplastic resin coating material by gripping an end of the base sheet with a claw portion provided on a conveyor roll, (c1′) a mechanism for sensing a position of the claw portion on the conveyor roll and press contacting on the conveyor roll a transfer roll having any of a mirror finish, a matt finish or a hologram finish applied previously to its outer peripheral surface by an ultraviolet curable resin coating material, (c2) a mechanism for heating the transfer roll to at least a temperature at which the thermoplastic resin coating material melts, (d1) a mechanism for peeling the base sheet from the transfer roll, and (d2) a mechanism for cooling the base sheet.

The present invention also proposes a sheet product that is manufactured by the above transfer method.

### BRIEF DESCRIPTION OF THE DRAWINGS

FIG. 1 is a side cross-sectional view showing the state of the base sheet on the conveyor roll in the present invention, shown directly before the base sheet is gripped by the claw portion.

FIG. 2 is a side cross-sectional view showing the state of the base sheet on the conveyor roll in the present invention, shown with the base sheet gripped by the claw portion.

FIG. 3 is a side cross-sectional view showing the state of the base sheet on the conveyor roll in the present invention, shown with the base sheet gripped by the claw portion pressed against the transfer roll.

FIG. 4 is a side cross-sectional view showing the state of the base sheet on the conveyor roll in the present invention, shown with the base sheet freed from the claw portion.

FIG. 5 is a side cross-sectional view showing the state of the base sheet on the conveyor roll in the present invention, shown with the freed base sheet being moved to a support roll.

FIG. 6 is the first of a continuous series of schematic views of the transfer method according to an embodiment of the present invention.

FIG. 7 is the second of a continuous series of schematic views of the transfer method according to an embodiment of the present invention.

FIG. 8 is the third of a continuous series of schematic views of the transfer method according to an embodiment of the present invention.

FIG. 9 is the fourth of a continuous series of schematic views of the transfer method according to an embodiment of the present invention.

FIG. 10 is the fifth of a continuous series of schematic views of the transfer method according to an embodiment of the present invention.

### EXPLANATION OF REFERENCE NUMERALS

1 Conveyor roll
2 Transfer roll
3 Gear chain
4 Conveyor belt
5 Claw portion
6 Base sheet
61 Pattern (plate)
62 Lateral positioning
63 Longitudinal positioning
64 Paper (obverse surface)
65 Paper (reverse surface)
66 Hollowed-out portion
67 Roll surface
68 Sheet obverse
69 Sheet reverse
70 Pattern plate obverse surface
71 Obverse surface
72 Hologram design
73 Mirror surface
74 Matt surface
75 Thermoplastic resin
76 Paper
77 Paper held by the claw on the cylinder
78 Obverse
79 Reverse
80 Processed sheet reverse surface
81 Mirror surface+raised embossed design
82 Raised portion (star design)
83 Recessed portion (face design)
84 Hologram design
85 Matt+embossed design
86 Sheet obverse turned upside down

### BEST MODE FOR CARRYING OUT THE INVENTION

The transfer method of the present invention comprises the steps of: (A) coating a thermoplastic resin coating material on a base sheet,

(B) supporting and conveying the base sheet coated with the thermoplastic resin coating material by gripping an end of the base sheet with a claw portion provided on a conveyor roll,

(C) providing a step wherein a position of the claw portion of the conveyor roll is sensed and a transfer roll having adhered and affixed to its outer peripheral surface a film to which any of a mirror finish, a matt finish or a hologram finish has been previously applied is press contacted on the conveyor roll under a condition in which the transfer roll is heated to at least a temperature at which the thermoplastic resin coating material melts, and

(D) peeling the base sheet from the transfer roll and cooling.

The transfer apparatus of the present invention comprises:

(a) a mechanism for coating a thermoplastic resin coating material on a base sheet,

(b) a mechanism for supporting and conveying the base sheet coated with the thermoplastic resin coating material by gripping an end of the base sheet with a claw portion provided on a conveyor roll,

(c1) a mechanism for sensing a position of the claw portion of the conveyor roll and press contacting on the conveyor roll a transfer roll having adhered and affixed to its outer peripheral surface a film to which any of a mirror finish, a matt finish or a hologram finish has been previously applied,

(c2) a mechanism for heating the transfer roll to at least a temperature at which the thermoplastic resin coating material melts,

(d1) a mechanism for peeling the base sheet from the transfer roll, and

(d2) a mechanism for cooling the base sheet.

Instead of the step (C), the transfer method of the present invention may include the step (C′) that uses a transfer roll having any of a mirror finish, a matt finish or a hologram finish applied previously to its outer peripheral surface by an ultraviolet curable resin coating material.

Also, instead of the mechanism (c1), the transfer apparatus of the present invention may include a mechanism (c1′) that uses a transfer roll having any of a mirror finish, a matt finish, or a hologram finish applied previously to its outer peripheral surface by an ultraviolet curable resin coating material.

Each of the steps (A) to (D) will now be described below.

First, in step (A), a thermoplastic resin coating material is coated on a base sheet.

The base sheet is a base selected from any one of paper, synthetic paper, non-wood paper, and film, and may be a multiple surface printing sheet having multiple printed surfaces formed on a single sheet by the application of various types of printing.

Thermoplastic resin coating material refers to various types of coating material (ink) having a thermoplastic resin as a binder. Various types of coating material (ink) sold by coating material (ink) manufacturers may be used.

As the mechanism (a) for embodying the step (A), that is, the mechanism for coating the thermoplastic resin coating material on the base sheet, there may be used a publicly known printing machine (coating machine). Solid printing that coats substantially the entire surface may be used, as may point printing that prints parts; in the case of a multiple printed surface sheet, each printed surface may be given a respective coating.

The thermoplastic resin coating material may be coated on the base sheet, the printing may be done on the thermoplastic resin coating material (example: aluminum silver ink, four-color ink), or it may be a layer vapor-deposited on the thermoplastic resin coating material.

The longitudinal length of the base sheet may be within that of the outer peripheral surface of the transfer roll and conveyor roll except for the claw portion, and the width of the base sheet may be any length that fits on the transfer roll and conveyor roll. It is desirable that the belt conveyor that pays out the base sheet and the sheet eject portion combine to form a size suitable for the paying out of sheets in accordance with the timing of the transfer roll and conveyor roll.

It is also desirable for the base sheet to have a flexible thickness so that it properly extends to, and wraps snugly around, the conveyor roll.

Next, in the step (B), the base sheet coated in step (A) with the thermoplastic resin is supported and conveyed by gripping an end of the base sheet with a claw portion provided on the conveyor roll.

That is, step (B) is at least carried out after step (A).

In summary, while small discrepancies arise with the conventional system in which the base sheets are drawn through and pressed by the rolls, and due to the gap from the thickness of the base sheet and slippage, there are small positional discrepancies when the base sheet is sandwiched between the rolls, since with this step (B) in which the base sheet is conveyed with the leading edge thereof gripped by the claw portion provided on the conveyor roll, there are no discrepancies, the position of the claw portion of the conveyor roll coinciding with the leading edge of the base sheet.

As the mechanism (b) for embodying the step (B), that is, the mechanism for supporting and conveying the base sheet coated with the thermoplastic resin by gripping the end of the base sheet with the claw portion provided on the conveyor roll, there may be used a specified printing machine (coating machine) used in the embodiments described hereinbelow.

Continuing on, in step (C), the position of the claw portion of the conveyor roll is sensed and the transfer roll having adhered and affixed to its outer peripheral surface a film to which any of a mirror finish, a matt finish or a hologram finish has been previously applied, in step (C′) the transfer roll having any of a mirror finish, a matt finish or a hologram finish applied previously to its outer peripheral surface by an ultraviolet curable resin coating material, is press contacted on the conveyor roll under a condition in which the transfer roll is heated to at least a temperature at which the thermoplastic resin coating material melts. The result of this is that the transfer roll film, or the embossment layer of ultraviolet curable resin, is press contacted against the thermoplastic resin coating material layer on the base sheet.

The transfer roll is prepared beforehand, and may be a roll (the transfer roll that becomes the heated roll) having affixed to all or part of the outer peripheral surface thereof a mirror film, a matt film or a hologram film or the like manufactured by a publicly known method. One or a plurality of types of film may be adhered and affixed to a single transfer roll. For example, a mirror finish film may be affixed to one portion, a matt finish film to another portion and a hologram finish film to yet another portion of the transfer roll. For the transfer film, it is desirable to use a film on which the patterns or designs (mirror or matt or hologram, etc.) to be transferred are formed of an ultraviolet curable resin coating material that has been confirmed to be able to withstand 8 hours at a temperature of 160° C. (no problem is caused by 8 hours of continuous operations at a temperature of 160° C.).

Or, a film applied with a mirror, matt or hologram pattern or embossed glass material manufactured by a known method that transmits ultraviolet light, or an ultraviolet curable resin coating material coated on the outer peripheral surface of a transfer roll, may, in the uncured state, with the embossed surface in close adherence with the outer peripheral surface, be cured by ultraviolet radiation from above the film or glass, after which the film or glass can be stripped from the ultraviolet curable resin coating material to form an embossed transfer surface, and confirmed to be able to withstand 8 hours at a temperature of 160° C. (no problem is caused by 8 hours of continuous operations at a temperature of 160° C.).

Also, as described with reference to step (B), the position of the claw portion coincides with the leading edge of the base sheet, so by sensing the position of the claw portion and synchronizing the rotary drive of the transfer roll so that with respect to the position to which it is desired to transfer a prescribed pattern or design at a prescribed base sheet position, it is possible to achieve a close, integrated adherence by the transfer film or recesses and protrusions of the embossed layer formed by the ultraviolet curable resin coating material that transfers the prescribed pattern or design to a prescribed position on the base sheet. When the heated transfer roll is closely contacted with the coating layer formed by the thermoplastic resin coating material, the coating layer melts, producing close, integrated adhesion to the surface shape of the transfer roll.

As the mechanism (c1) that embodies the step (C) and the mechanism (c1′) that embodies the step (C′), that is, as the mechanism for sensing the position of the claw portion on the conveyor roll and press contacting the transfer roll to the conveyor roll, there may be used the printing machine (coating machine) specified in the following embodiments.

During transferring, the transfer film adhered to the transfer roll or the thermoplastic resin coating material coated on the transfer roll

Also, as described with reference to step (B), the position of the claw portion coincides with the leading edge of the base sheet, so by sensing the position of the claw portion and synchronizing the rotary drive of the transfer roll so that with respect to the position to which it is desired to transfer a prescribed pattern or design at a prescribed base sheet position, it is possible to achieve a close, integrated adherence by the transfer film or recesses and protrusions of the embossed layer formed by the ultraviolet curable resin coating material that transfers the prescribed pattern or design to a prescribed position on the base sheet. When the heated transfer roll is closely contacted with the coating layer formed by the thermoplastic resin coating material, the coating layer melts, producing close, integrated adhesion to the surface shape of the transfer roll.

As the mechanism (c1) that embodies the step (C) and the mechanism (c1′) that embodies the step (C′), that is, as the mechanism for sensing the position of the claw portion on the conveyor roll and press contacting the transfer roll to the conveyor roll, there may be used the printing machine (coating machine) specified in the following embodiments.

During transferring, the transfer film adhered to the transfer roll or the thermoplastic resin coating material coated on the transfer roll may be provided with a vapor deposition layer or coating material layer that is thick enough not to cause a loss of the surface transfer effect so as not to move the ink and thermoplastic resin on the printed base sheet from the transfer film.

The transfer film may be adhered and affixed over all or part of the outer peripheral surface of the above roll (the heated roll forming the transfer roll). If it is adhered and affixed over part, the film having geometric or pattern or design cutouts, or the film remaining after the cutouts (the film with the cutout shapes) may be adhered and affixed. Or, after the transfer film has been adhered and affixed over all of the outer peripheral surface of the transfer roll or adhered and affixed over part, parts of the adhered and affixed transfer film may be cut and peeled from the outer peripheral surface of the transfer roll and just the necessary portions left. Using any of the above means, recesses and protrusions are formed on the base sheet by the transfer film adhered and affixed to the outer peripheral surface of the transfer roll. That is, a shape cut out of the transfer film adhered and affixed to the transfer roll forms a difference in level that is the amount of the thickness of the transfer film, so the cutout transfer film forms a recessed shape on the base sheet, making it possible to form a transfer process in which the lower layer in contact with the edge of the transfer film forms a raised shape. Similarly, the cutout portion of a transfer film cutout shape forms a raised shape on the base sheet, making it possible to form a transfer process in which the remaining portion adhered and affixed to the outer peripheral surface of the transfer roll forms a recessed shape.

Similarly, the ultraviolet curable resin coating material may be directly coated over all or part of the outer peripheral surface of the above roll (the heated roll forming the transfer roll), or may be coated over all or part of the film or embossed glass surface. Or, both the outer peripheral surface and the film or glass may be coated. When the whole or part of the surface is coated, the whole surface of the roll or the film or glass is coated, and the portions of the geometric or pattern or design shapes and in the uncured state the embossed surface is brought into close adherence with the coated surface of the roll, and after curing by ultraviolet radiation from above, the film is stripped from the resin coating material that transferred the embossed layer to the outer peripheral surface of the roll. Or, the whole surface of the roll or the film or glass and the portions of the geometric or pattern or design shapes may be coated and in the uncured state, with the embossed surface brought into close adherence with the coated surface of the roll, and partially cutout or hollowed-out paper or masking film is utilized to form ultraviolet radiation shielding portions, and after just the portions that transmit ultraviolet radiation are cured by ultraviolet radiation, the embossing material may be stripped from the resin coating material that transferred the embossed layer to the outer peripheral surface of the roll. When at this time there exist both ultraviolet curable resin coating material portions that are cured and portions that not yet cured, or unwanted portions in an uncured state between the film or glass embossed surface and the roll where partial shielding from ultraviolet radiation has been applied, which can be removed with alcohol or toluene, or left to set, or the cured portion can be protected by tape or the like and another pattern applied to the uncured portion by the same transfer method.

The roll can have laminates formed by combining ultraviolet curable resin coating material and ultraviolet curable resin coating material, or ultraviolet curable resin coating material and transfer film, or transfer film and transfer film and the like, thereby forming a difference in level that is the amount of the thickness of the laminations of transfer film or ultraviolet curable resin coating material, which may be utilized to transfer embossed patterns and designs with recessed and raised shapes to the base sheet.

There is no particular limitation on the method of affixing the transfer film, which may be done using an adhesive or the like. As an adhesive, there may be used an ultraviolet curable resin having good heat resistance properties. The transfer roll may be processed to allow a clamp to be mounted that can be used to clamp the film on the outer peripheral surface of the transfer roll. The clamp can be used for the mounting after the film is adhered to a base plate made of metal or plastic.

As in the case of the transfer film, there is no particular limitation on the method of affixing the transfer ultraviolet curable resin coating material formed of ultraviolet curable resin coating material. Just ultraviolet curable resin may be used, or a coating material or an adhesive may be used to improve the adhesion between layers. Also, the transfer roll may be processed to allow a clamp to be mounted that can be used to clamp the coating material on the outer peripheral surface of the transfer roll. The clamp can be used for the mounting after the ultraviolet curable resin embossed layer is affixed to a base plate made of metal or plastic.

In this way, as the transfer roll, a transfer film formed of various mirror films, matt films and hologram films and the like can be adhered and affixed, or an embossed layer of an ultraviolet curable resin coating material can be formed and affixed on the outer peripheral surface of the transfer roll and the required pattern or design transferred, and the transfer film or ultraviolet curable resin coating material embossed layer partly adhered and affixed, or coated, or partly adhered and affixed in layers, to thereby simultaneously form embossed patterns and designs with recessed and raised shapes.

There is no limitation on the specific configuration of the transfer roll, as long as it is equipped with a temperature-adjustable heating mechanism. The transfer roll may be a metal-plated polished roll having a hard chrome plated finish, for example, that uses an externally attached heating apparatus that circulates a heating medium or the like, or incorporates a heating mechanism. Or, the transfer roll may be heated by an external heating apparatus to heat the surface of the heating roll. There is no particular limitation on the method of heating the transfer roll, which may be heated by steam, electricity or oil or the like.

Also, the heating temperature will differ depending on the thermal properties of the ultraviolet curable resin coating material used, but should be heated to at least a temperature at which the ultraviolet curable resin coating material melts.

Also, in step (D) the base sheet is peeled from the transfer roll and cooled to obtain a product on which the required pattern or design is transferred to the required position on the base sheet.

As the mechanism (d1) for embodying the step (D), that is, the mechanism for peeling the base sheet from the transfer roll, there may be used a publicly known apparatus mechanism that is already being marketed. For example, as the mechanism (d1), there may be used a baffle plate that prevents further close adhesion to the transfer roll. As the mechanism (d2), that is, the mechanism for cooling the base sheet, there is a method that blows cool air, but with it being desirable to carry out cooling by disposing the roll so that the cool air is blown on the base sheet directly after it is peeled from the transfer roll, it may be arranged to be passed through a zone to cool the layered product.

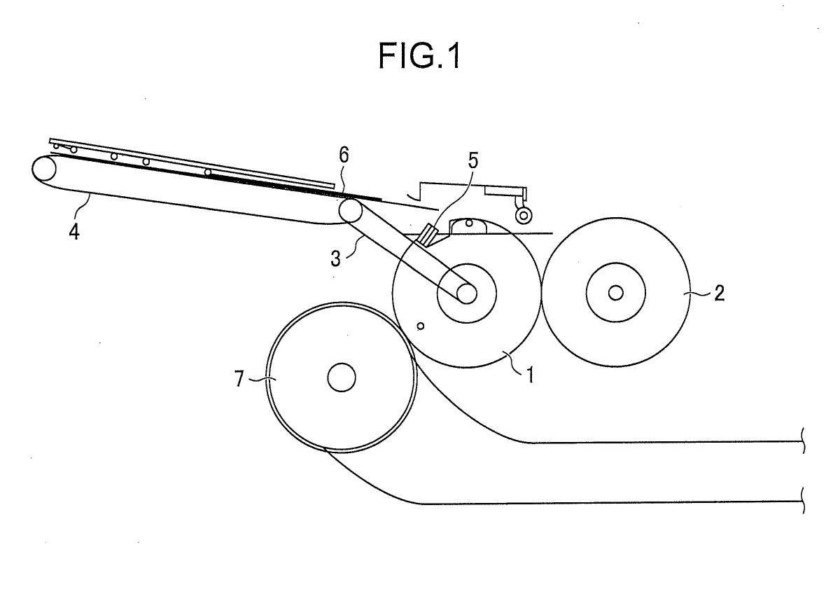

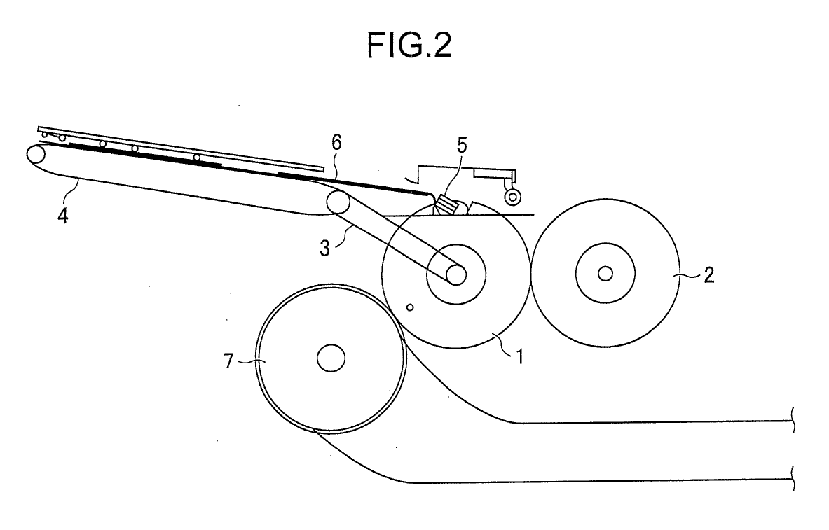

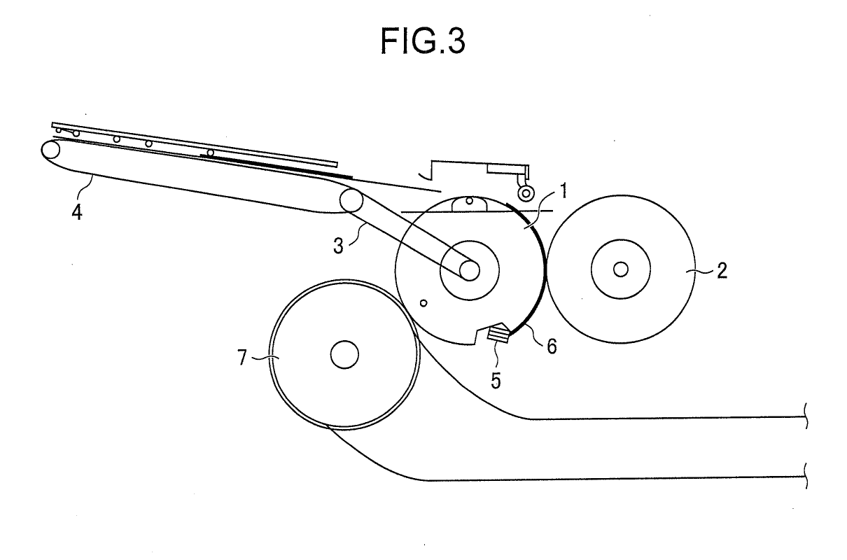

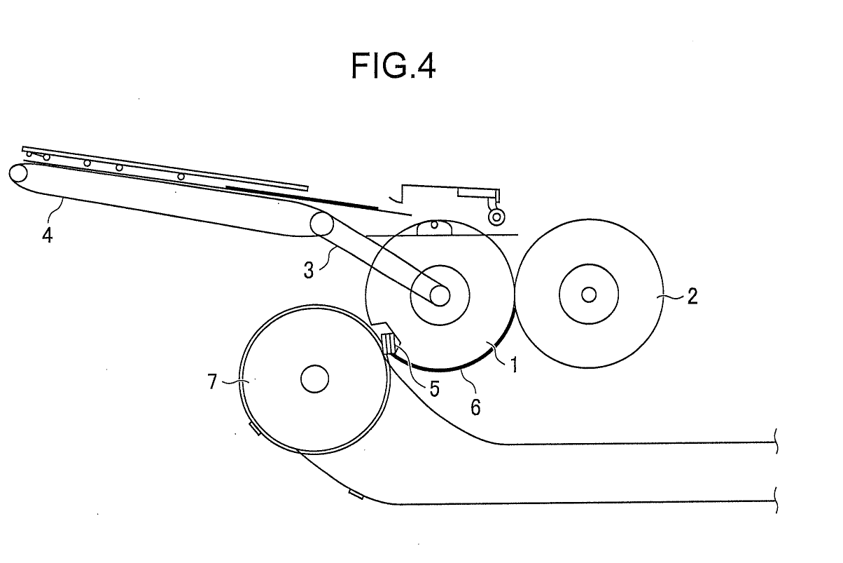

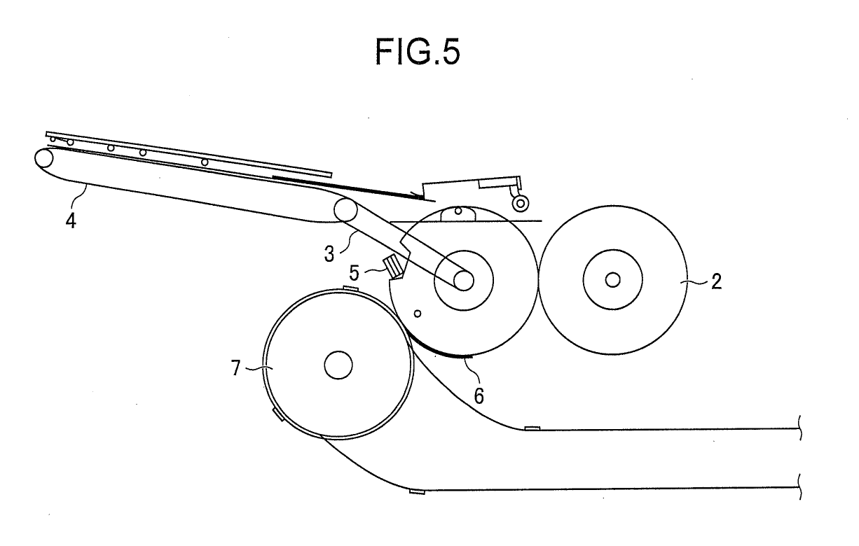

With reference to the steps (B) and (D), the following is added with reference to FIGS. 1 to 5. In FIGS. 1 to 5, there is no description relating to the step (A) of coating a thermoplastic resin coating material on the base sheet or the base sheet cooling step (d2).

First, conveyor roll 1 is generally made of a roll of rubber blanket or the like, but depending on the hardness of the transfer film (PP laminate paper or the like having a surface hardness or PP laminate paper having an aluminum deposition surface forming a hologram surface), plastic or other such material may be used. A recessed and raised shape may be formed on part of the surface.

For the transfer roll 2, a heated roll was used around the outer peripheral surface around which a pre-manufactured transfer film (hologram film) was wound having a cutout in the shape of a star pattern or the like and adhered and affixed at a plurality of points. Also, a part of the transfer film was intentionally overlapped and adhered and affixed. Or, an ultraviolet curable resin coating material with a star shaped cutout was affixed to the outer peripheral surface of the heated roll and part of a pre-manufactured transfer film was intentionally overlaid and adhered and affixed. Or, an ultraviolet curable resin coating material with a star shaped cutout was affixed to the outer peripheral surface of the heated roll on which an ultraviolet curable resin coating material was intentionally coated on a part thereof, and cured and affixed. The transfer roll 2 and the conveyor roll 1 was connected by a gear chain 3 and controlled to rotate at the same speed.

The method of conveying the base sheet synchronizes the speeds of the conveyor roll 1 and the conveyor belt 4 by interlocking with a cam that is fixed to an end of the rotary shaft of the conveyor roll and thus rotates at the same speed as the conveyor roll. For a base sheet to be delivered properly between the transfer roll and the conveyor roll, it is moved towards a claw portion attached to the conveyor roll in accordance with the state of descent of a stop plate adjusted to the proper angle and proper position, and stops when the stop plate contact face at the leading edge of the base sheet and the leading edge of the base sheet 6 on the conveyor belt 4 make contact in a straight line, or stops when the stop plate contact face at the leading edge of the base sheet 6 and the leading edge of the base sheet on the conveyor belt 4 make contact at two or more points along the straight line of the leading edges. After lateral and longitudinal positioning carried out during this, the claw portion 5 attached to the conveyor roll is rotated until it reaches a position at a timing for gripping the prescribed leading edge of the base sheet 6 at a prescribed dimension, at which time, as the stop plate is interlocked with the configuration of the cam that is fixed to the end of the rotary shaft of the conveyor roll and therefore rotates at the same speed, the stop plate rises and the base sheet 6 that has stopped on the belt conveyor starts to advance again under the rotatory power of the conveyor belt 4, moving it towards the conveyor roll. After the base sheet on the conveyor belt 4 passes under the stop plate, from leading edge to trailing edge, the stop plate interlocked with the cam configuration again descends, bringing the contact face of the base sheet into contact with the leading edge of the next base sheet 6 on the conveyor belt 4, forming a state in which the base sheet is stopped.

The speed at which the base sheet 6 is conveyed is adjusted by adjusting the rotary speed of the conveyor roll 1 so that it rotates at the same speed as the transfer roll 2 (in the reverse direction). To be properly delivered to the claw portion, all or just the trailing edge portion of the first base sheet rides on the conveyor belt 4. The conveyor belt has a surface formed of rubber or a plastic resin material and has a surface condition that enables a base sheet 6 stopped by the stop plate to stop, and enables the base sheet 6 to be conveyed ahead again when the stop plate rises.

The base sheet 6 on the conveyor belt 4 is conveyed straight ahead with an appropriate force between a plurality of attached rollers. Or, a suction device that is not shown is attached having a suction port, not shown, at the conveyor belt 4 that sucks base sheets onto the conveyor belt 4 as they are conveyed ahead, interlocked with the configuration of a cam fixed to one end of the rotary shaft of the conveyor roll 1 to rotate at the same speed thereof, producing a repeated up and down motion in which the descending motion of the stop plate is timed to coincide with the base sheet contact surface of the stop plate contacting the leading edge of a base sheet 6, whereby it is stopped on the conveyor belt 4 while slipping.

When the same dimension that is the distance from a starting point which is taken to be the point of contact on the conveyor belt 4 that is stopped by the base sheet contact surface of the stop plate contacting the leading edge of a base sheet when the stop plate has descended, and an end point which is taken to be a point at which the base sheet on the conveyor belt 4 advancing along a straight, extended line contacts the outer peripheral surface of the conveyor roll 1, plus the length needed for the leading edge of the base sheet 6 to be gripped by the claw portion 5 on the conveyor roll 1 (around 5 to 10 mm), is covered by the portion on which the claw portion 5 is affixed on the conveyor roll 1 rotating and reaching a position on the near side of the outer peripheral surface from a starting point that is the point at which the base sheet moving forward on the conveyor belt 4 along a straight, extended line contacts the outer peripheral surface of the conveyor roll 1, the stop plate is raised by the cam configuration moving in unison with the rotation of the conveyor roll.

With the raising of the stop plate, the base sheet 6 stopped while slipping on the conveyor belt 4 obtains the driving force of the conveyor belt 4 and again moves forward towards the conveyor roll 1. The base sheet 6 is moved straight ahead by the power of the conveyor belt 4 rotating at the same speed as the conveyor roll 1, along a straight, extended line, and when it enters the claw portion 5 at the point of contact with the outer peripheral surface of the conveyor roll 1, with the conveyor roll 1 and the base sheet 6 rotating and advancing at the same speed, the necessary length for gripping of the base sheet 6 is inserted into the claw portion 5 in the open state, in contact with the claw affixed to one side of the conveyor roll, and as it rotates and advances and when the claw portion 5 reaches the sheet paper ejection roll 7 at the position at which the base sheet on which transfer processing has been applied is ejected, a clutch lever attached to one end of a claw portion 5 shaft to which the opening/closing claw portion 5 is attached is rotated to, and stopped at, a position at which the claw portion 5 opens, by a clutch bar attached to the end of the main body of the present apparatus, the conveyor roll rotates and the necessary length for the leading edge of the base sheet 6 to be gripped by the claw portion 5 on the conveyor roll 1 (5-10 mm) is inserted into, and contacts, the claw portion 5, the clutch lever contacts and is rotated by the clutch bar attached to the end of the main body at a position at which the leading edge of the rotating and advancing base sheet 6 can be gripped, and the claw portion 5 that had been in an open state closes and is housed so that it fits within the outer circumference of the conveyor roll 1, whereby the leading edge of the base sheet 6 is gripped by the claw portion 5, the leading edge of the base sheet 6 inserted into the claw portion is fixed, fixing the position as it is wound onto the conveyor roll 1 from the leading edge to the trailing edge. Therefore, in accordance with the rotation of the conveyor roll 1 the base sheet 6 fixed in position on the conveyor roll 1 by the claw portion 5 is moved forward (conveyed) to the contact surfaces of the transfer roll 2 and conveyor roll 1, enabling the transfer process to take place without deviation.

After the base sheet 6 wound around the conveyor roll 1 is subjected to heat and pressure between the conveyor roll 1 and transfer roll 2, it moves towards the paper ejection roll 7. When the claw portion 5 reaches the paper ejection roll 7, the clutch lever again contacts the clutch bar and rotates to the open position, and with the claw portion 5 in the stopped condition at the position where it opened, the base sheet 6 is released going from the leading edge to the trailing edge as the conveyor roll rotates.

A suction mechanism may be suitably incorporated in the paper ejection roll 7 toward which the base sheet 6 moves, or equipped with a cooling device. A cool-air blower type cooling apparatus may be provided directly after the transfer processing (the portion in contact with the transfer roll).

The lateral position of the base sheet 6 can be set by measuring beforehand the position of the base sheet 6 to which a pattern or design or the like is to be applied, and the position of the transfer roll 2, and align the left or right edge of the base sheet using a guide rail or the like, or after it is stopped by the stop plate, a lateral alignment device may be used to align the leading edge at rest.

While not shown, if necessary, the obverse and reverse sides of the base sheet 6 can be heated by using a heating device provided above the conveyor belt 4 and a heating device provided below the conveyor belt 4.

Heating the base sheet 6 makes it easier to form a (transfer) pattern on the base sheet 6.

Positional deviation can be further avoided by correcting curl in the base sheet 6 so that it extends straight ahead.

When the base sheet 6 re-advances from the stop position, it may be held down with a guide so it does not deviate. The upper surface of the base sheet 6 may be held down with a guide to prevent the base sheet bouncing up when it contacts the conveyor roll 1. When the base sheets 6 run continuously, an ordinary sheet stacking device or the like may be used and the timing of the flow of the base sheets 6 aligned so that the first base sheet 6 comes uppermost offset from the lower tier base sheets 6; the conveyance may also be timed so sheets in front and behind the base sheet 6 do not overlap.

As described in the foregoing, the transfer roll 2 and the conveyor roll 1 are connected beforehand by a gear chain 3 and rotate at the same speed, passing the base sheet 6 to which it is desired to apply patterns and designs and the like between the transfer roll 2 and conveyor roll 1, enabling the patterns and designs to be accurately transferred to a desired position on the base sheet 6 without longitudinal or lateral deviation from the transfer starting position.

When the pressure and heat are applied to the transfer roll 2 and the conveyor roll 1, it is preferable that the outer peripheral diameters of both be the same, so that after one rotation the rotation starting point always comes to the same position; from the transfer start to after completion, the position must return to transfer starting point, that is, adjustment must be carried out to ensure there is no discrepancy between the starting points and finishing points of the transfer roll and the conveyor roll 1.

Thus, the base sheet 6 is gripped by the claw portion 5 of the conveyor roll 1 and the leading edge position fixed, wraps around the outer periphery of the conveyor roll 1, passes through the press contact location between the conveyor roll 1 and the transfer roll 2, with the base sheet 6 being subjected to the pressure and heat going from the leading edge to the trailing edge, directly after which it is cooled by a cooling device that is not shown and, released by the claw portion 5, the base sheet 6 is moved to the paper ejection roll 7 and conveyed by the paper ejection roll 7.

The base sheet 6 conveyed by the paper ejection roll 7 is ejected over the paper ejection roll 7. The claw portion 5 that opens to release the base sheet 6 moves in the open state to grip the next base sheet 6.

Because in the sheet transfer method of the present invention the base sheet is supported and conveyed with the end portion of the sheet gripped in the claw portion provided on the conveyor roll, it is accurately conveyed to the press contact location, and by sensing the portion and synchronizing the rotary drive of the transfer roll, it is possible to transfer the same pattern or design to the same position on the base sheet of various printed materials and the like. If required, an embossed pattern can also be formed. Thus, the prescribed pattern or design is accurately transferred to the prescribed position, even when the printing sheet is, for example, one having multiple printed surfaces, claw therefore enabling processing to be carried out with a very high yield.

The transfer roll used is one having adhered and affixed to its outer peripheral surface a transfer film applied with any of a mirror finish, a matt finish or a hologram finish, or having any of a mirror finish, a matt finish or a hologram finish on the outer peripheral surface of the transfer roll formed by an ultraviolet curable resin coating material. Therefore different finishes can be readily accommodated by suitably changing the adhered transfer film or suitably changing the ultraviolet resin layer.

Also, the transfer film applied with any of a mirror finish, a matt finish or a hologram finish is adhered and affixed over all or part of the outer peripheral surface of the transfer roll, or is adhered and affixed in layers over all or part. Also, any of a mirror finish, a matt finish or a hologram finish formed by an ultraviolet curable resin is formed over all or part of the outer peripheral surface of the transfer roll, or is formed in layers over all or part of the surface. When formed in layers over all or part of the surface, a difference in level that is the amount of the thickness of the resin layer is formed and this difference in level forms embossing having a raised/recessed shape, which makes it possible to also form an embossed pattern (design) on the transferred mirror, matt or hologram by the transfer process that forms the design or pattern and the like.

Also, if the ultraviolet curable resin coating material coated on the base sheet is closely adhered to the transfer roll in a pre-heated condition, the heating temperature of the heated roll that supports the transfer roll can be decreased.

The sheet transfer apparatus of the present invention comprises a mechanism for coating a thermoplastic resin coating material, a mechanism for supporting and conveying by means of a claw portion provided on a conveyor roll, a mechanism for press contacting the transfer roll, a mechanism for heating the transfer roll, a mechanism for peeling the base sheet from the transfer roll, and a mechanism for cooling the base sheet, which enables many publicly known general-purpose mechanisms to be utilized, making it possible to readily implement the transfer processing without incurring costs.

Also, various printed materials or various film sheets can be utilized for as the base sheet for the sheet product of the invention, and various types of mirror finish, matt finish or hologram finish, or embossing, may be used to decorate the surface thereof, so there is expected to be a wide range of utilization.

### Embodiment 1

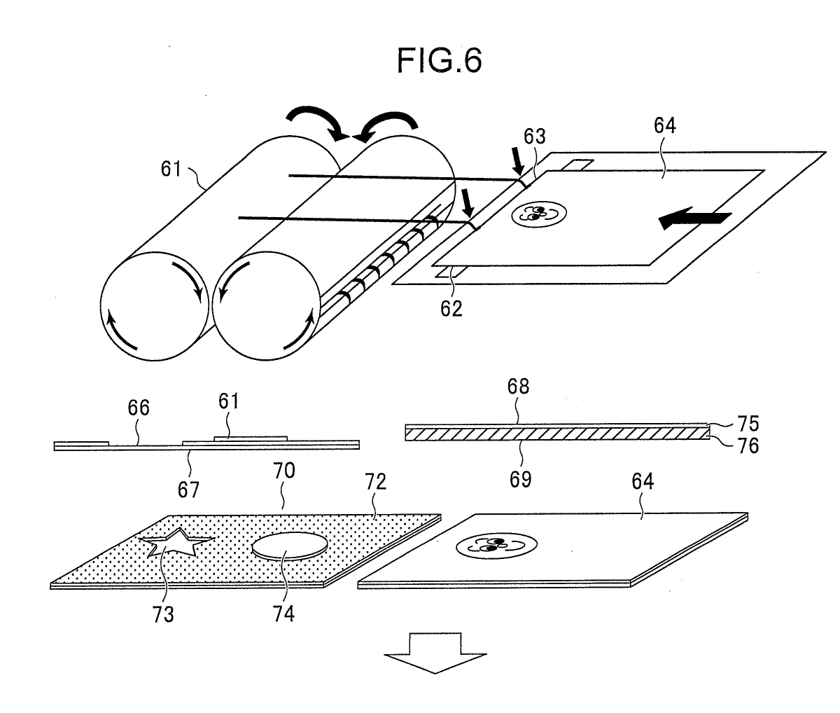

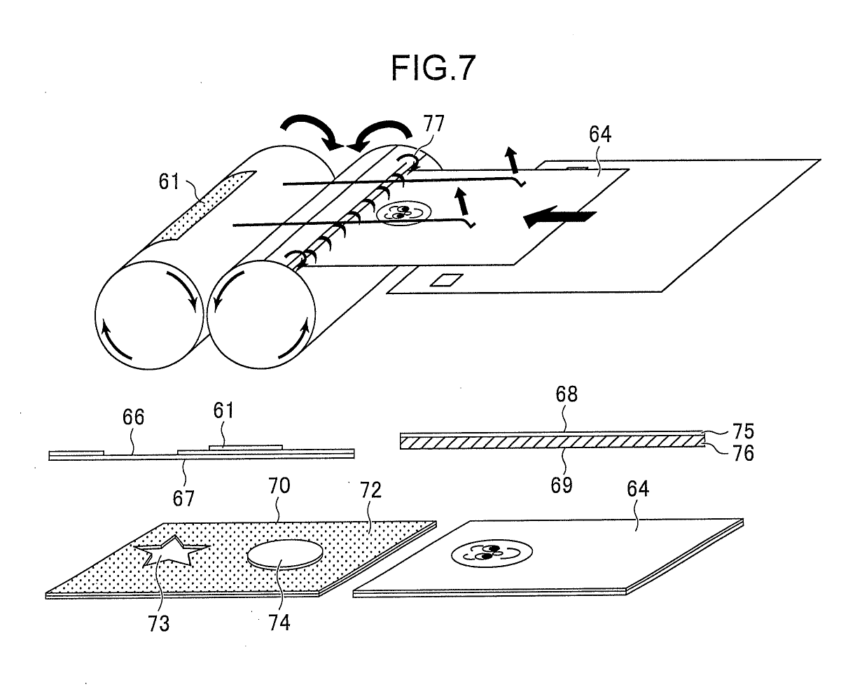

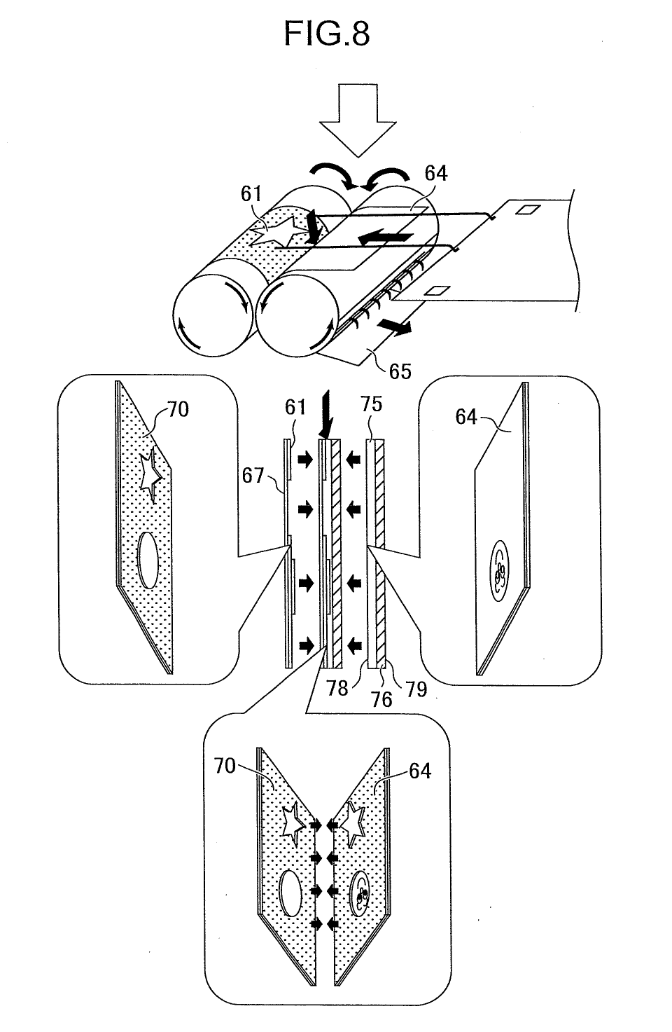

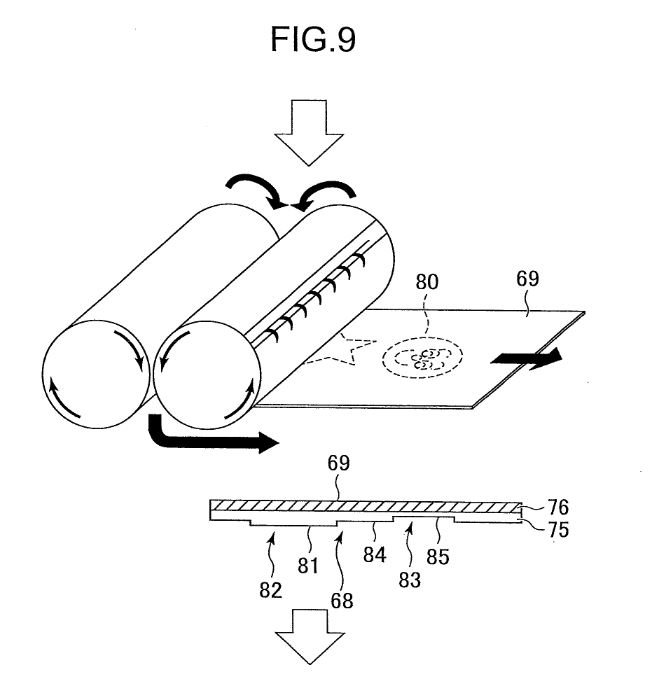

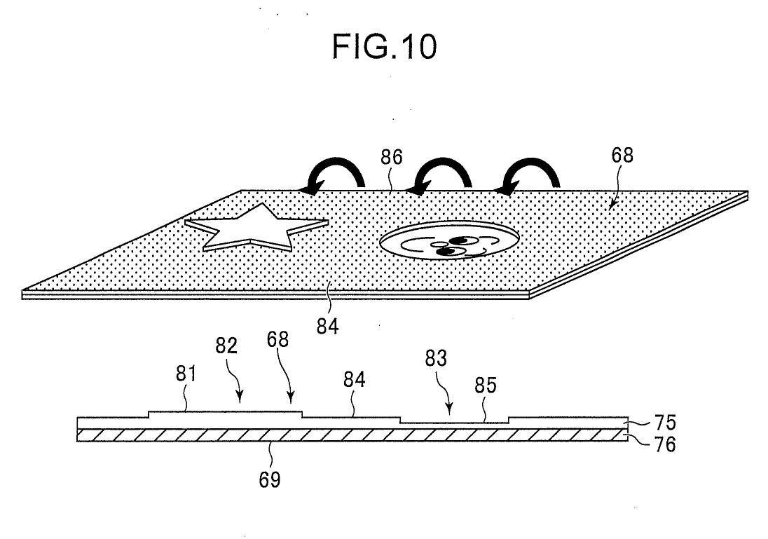

The following manufacturing was carried out using the apparatus shown in FIGS. 6 to 10.

Step (A):

As the base sheet, 26.5 kg Perfect W duodecimo sheets manufactured by Hokuetsu Paper Company were used. These were cut in half and a gravure plate having a plate depth of 100 lines 80 μm was used with a sheet gravure printer manufactured by Hirose Iron Works. The sheets were partially coated at 60 m/min. with thermoplastic resin coating material composed of Aquacoat KP16 varnish manufactured by Toyo Ink Company mixed and diluted with IPA and water at 10:4.2:1.8; the residual solids amount after drying was 3 g/m².

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

As a transfer film for hologram patterns, there was used PET film No. PO25 manufactured by Toray Company having a film thickness of 12 μm coated on the easy adhesive side with 3 g/m² (non-diluted) coated with an ultraviolet curable resin coating material, FDFC-150 varnish, manufactured by Toyo Ink Company, to which, in the uncured state, the hologram surface of a hologram film manufactured experimentally in-house was closely adhered, and after curing, the hologram film was peeled off and the hologram layer comprised of the ultraviolet curable resin coating material formed by the transfer film was used to form a star shaped cutout at a specific position.

As a transfer film for matt patterns, there was used PET film No. PO25 manufactured by Toray Company having a film thickness of 12 μm coated on the easy adhesive side with 3 g/m² (non-diluted) of an ultraviolet curable resin coating material, FDFC-150 varnish, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

For a transfer roll, G17 bond manufactured by Konishi Company was coated on the opposite surface of the above transfer film used for a hologram pattern to produce, after drying, a residual solids amount of 8 g/m², and was closely adhered to the transfer roll at a normal temperature.

Continuing on, G17 bond manufactured by Konishi Company was coated on the opposite side of the matt pattern transfer film to the matt surface which, after drying, had a residual solids amount of 8 g/m², and was closely adhered to the hologram surface of the transfer roll hologram transfer film.

Then, the base sheet was paid out from the conveyor roll at a speed of 10 m/min. between the conveyor roll and the transfer roll heated to 100° C. at a pressure of 2000 N/cm for press contacting while using a heater over the belt conveyor to heat the surface temperature of the base sheet to 40° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Embodiment 2

The following manufacturing was carried out using the apparatus shown in FIGS. 6 to 10.

Step (A):

As the base sheet, 26.5 kg Perfect W duodecimo sheets manufactured by Hokuetsu Paper Company were used. These were cut in half and a gravure plate having a plate depth of 100 lines 80 μm was used with a sheet gravure printer manufactured by Hirose Iron Works. The sheets were partially coated at 60 m/min. with thermoplastic resin coating material composed of Terucoat A-98 varnish manufactured by Arakawa Toryo Kogyo mixed and diluted with IPA and water at 10:4.2:1.8; the residual solids amount after drying was 3 g/m².

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

As a transfer film for hologram patterns, there was used PET film No. PO25 manufactured by Toray Company having a film thickness of 12 μm coated on the easy adhesive side with 2.5 g/m² (non-diluted) of an ultraviolet curable resin coating material, FDFC-80 varnish, manufactured by Toyo Ink Company, to which, in the uncured state, the hologram surface of a hologram film manufactured experimentally in-house was closely adhered, and after curing, the hologram film was peeled off and the hologram layer comprised of the ultraviolet curable resin coating material formed by the transfer film was used to form a star shaped cutout at a specific position.

As a transfer film for matt patterns, there was used PET film No. PO25 manufactured by Toray Company having a film thickness of 12 μm coated on the easy adhesive side with 2.5 g/m² (non-diluted) of an ultraviolet curable resin coating material, FDFC-80 varnish, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

For a transfer roll, G17 bond manufactured by Konishi Company was coated on the opposite surface of the above transfer film used for a hologram pattern to produce, after drying, a residual solids amount of 7 g/m², and was closely adhered to the transfer roll at a normal temperature.

G17 bond manufactured by Konishi Company was coated on the opposite side of the matt pattern transfer film to the matt surface to produce, after drying, a residual solids amount of 7 g/m², and was closely adhered to the hologram surface of the transfer roll hologram transfer film.

Then, the base sheet was paid out from the conveyor roll at a speed of 10 m/min. between the conveyor roll and the transfer roll heated to 110° C. at a pressure of 2000 N/cm for press contacting while using a heater over the belt conveyor to heat the surface temperature of the base sheet to 50° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Embodiment 3

The following manufacturing was carried out using the apparatus shown in FIGS. 6 to 10.

Step (A):

As the base sheet, 26.5 kg Perfect W duodecimo sheets manufactured by Hokuetsu Paper Company were used. These were cut in half and a gravure plate having a plate depth of 100 lines 80 μm was used with a sheet gravure printer manufactured by Hirose Iron Works. The sheets were partially coated at 60 m/min. with thermoplastic resin coating material composed of Terucoat A-98 varnish manufactured by Arakawa Toryo Kogyo mixed and diluted with IPA and water at 10:4.2:1.8, to produce a residual solids amount after drying of 3 g/m².

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

As a transfer film for hologram patterns, there was used PET film No. PO25 manufactured by Toray Company having a film thickness of 12 μm coated on the easy adhesive side with 2.5 g/m² (non-diluted) of an ultraviolet curable resin coating material, FDFC-80 varnish, manufactured by Toyo Ink Company, to which, in the uncured state, the hologram surface of a hologram film manufactured experimentally in-house was closely adhered, and after curing, the hologram film was peeled off and the hologram layer comprised of the ultraviolet curable resin coating material formed by the transfer film was used to form a star shaped cutout at a specific position.

As a transfer film for matt patterns, there was used PET film No. PO25 manufactured by Toray Company having a film thickness of 12 μm coated on the easy adhesive side with 2.5 g/m² (non-diluted) of an ultraviolet curable resin coating material, FDFC-80 varnish, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

For a transfer roll, G17 bond manufactured by Konishi Company was coated on the opposite surface of the above transfer film used for a hologram pattern to produce, after drying, a residual solids amount of 7 g/m², and was closely adhered to the transfer roll at a normal temperature.

G17 bond manufactured by Konishi Company was coated on the opposite side of the matt pattern transfer film to the matt surface to produce, after drying, a residual solids amount of 7 g/m², and was closely adhered to the hologram surface of the transfer roll hologram transfer film.

Then, the base sheet was paid out from the conveyor roll at a speed of 20 m/min. between the conveyor roll and the transfer roll heated to 120° C. at a pressure of 2000 N/cm for press contacting while using a heater over the belt conveyor to heat the surface temperature of the base sheet to 50° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Embodiment 4

The following manufacturing was carried out using the apparatus shown in FIGS. 6 to 10.

Step (A):

As the base sheet, OK Topcoat 110 g/m² sheets manufactured by Oji Paper Company were cut in half, and a film (#3162 manufactured by Toyobo Company) having a 4 μm layer of soft polypropylene with a softening temperature of 120° C. and a base 25 μm thick composed of biaxially oriented polypropylene was coated on the opposite surface to the polypropylene coated surface with an adhesive composed of D-Tight 6920 manufactured by DIC Corporation mixed with PL hardener 50 in a ratio of 15:1 using a sheet film laminator manufactured by Matsumoto Kikai Mfg. to produce a residual solids amount after drying of 5 g/m², and was adhered to one side of the above sheets.

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

As a transfer film for hologram patterns, there was used PET film No. PO25 manufactured by Toray Company having a film thickness of 12 μm coated on the easy adhesive side with 3 g/m² (non-diluted) of an ultraviolet curable resin coating material, FDFC-150 varnish, manufactured by Toyo Ink Company, to which, in the uncured state, the hologram surface of a hologram film manufactured experimentally in-house was closely adhered, and after curing, the hologram film was peeled off and the hologram layer comprised of the ultraviolet curable resin coating material formed by the transfer film was used to form a star shaped cutout at a specific position.

As a transfer film for matt patterns, there was used PET film No. PO25 manufactured by Toray Company having a film thickness of 12 μm coated on the easy adhesive side with 2.5 g/m² (non-diluted) of an ultraviolet curable resin coating material, FDFC-150 varnish, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

For a transfer roll, G17 bond manufactured by Konishi Company was coated on the opposite surface of the above transfer film used for a hologram pattern to produce, after drying, a residual solids amount of 9 g/m², and was closely adhered to the transfer roll at a normal temperature.

G17 bond manufactured by Konishi Company was coated on the opposite side of the matt pattern transfer film to the matt surface to produce, after drying, a residual solids amount of 9 g/m², and was closely adhered to the hologram surface of the transfer roll hologram transfer film.

Then, the base sheet was paid out from the conveyor roll between the conveyor roll and the transfer roll heated to 110° C. for press contacting while using a heater over the belt conveyor to heat the surface temperature of the base sheet to 50° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Embodiment 5

The following manufacturing was carried out using the apparatus shown in FIGS. 6 to 10.

Step (A):

As the base sheet, 26.5 kg Perfect W duodecimo sheets manufactured by Hokuetsu Paper Company were used. These were cut in half and a gravure plate having a plate depth of 100 lines 80 μm was used with a sheet gravure printer manufactured by Hirose Iron Works. The sheets were partially coated at 60 m/min. with thermoplastic resin coating material composed of Terucoat A-98 varnish manufactured by Arakawa Toryo Kogyo mixed and diluted with IPA and water at 10:4.2:1.8; the residual solids amount after drying was 3 g/m². Sheets also coated with gravure ink LRC-UL Silver 11 manufactured by Tokyo Printing Ink to produce after drying a residual solids amount of 2.5 g/m².

Steps (B)-(C):

For the conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

As a transfer film for hologram patterns, there was used PET film No. PO25 manufactured by Toray Company having a film thickness of 12 μm coated on the easy adhesive side with 2.5 g/m² (non-diluted) of an ultraviolet curable resin coating material, FDFC-80 varnish, manufactured by Toyo Ink Company, to which, in the uncured state, the hologram surface of a hologram film manufactured experimentally in-house was closely adhered, and after curing, the hologram film was peeled off and the hologram layer comprised of the ultraviolet curable resin coating material formed by the transfer film was used to form a star shaped cutout at a specific position.

As a transfer film for matt patterns, there was used PET film No. PO25 manufactured by Toray Company having a film thickness of 12 μm coated on the easy adhesive side with 2.5 g/m² (non-diluted) of an ultraviolet curable resin coating material, FDFC-80 varnish, manufactured by Toyo Ink Company, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

For a transfer roll, G17 bond manufactured by Konishi Company was coated on the opposite surface of the above transfer film used for a hologram pattern to produce, after drying, a residual solids amount of 7 g/m², and was closely adhered to the transfer roll at a normal temperature.

G17 bond manufactured by Konishi Company was coated on the opposite side of the matt pattern transfer film to the matt surface to produce, after drying, a residual solids amount of 7 g/m², and was closely adhered to the hologram surface of the transfer roll hologram transfer film.

Then, the base sheet was paid out from the conveyor roll at a speed of 20 m/min. between the conveyor roll and the transfer roll heated to 120° C. at a pressure of 2000 N/cm for press contacting while using a heater over the belt conveyor to heat the surface temperature of the base sheet to 50° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Embodiment 6

The following manufacturing was carried out using the apparatus shown in FIGS. 6 to 10.

Step (A):

As the base sheet, OK Topcoat 110 g/m² sheets manufactured by Oji Paper Company were cut in half, and a film (#3162 manufactured by Toyobo Company) having a 4 μm layer of soft polypropylene with a softening temperature of 120° C. and a base 25 μm thick composed of biaxially oriented polypropylene was coated on the opposite surface to the polypropylene coated surface with an adhesive composed of D-Tight 6920 manufactured by DIC Corporation mixed with PL hardener 50 in a ratio of 15:1 using a sheet film laminator manufactured by Matsumoto Kikai Mfg. to produce a residual solids amount after drying of 5 g/m², and was adhered to one side of the above sheets.

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

For a transfer roll, an ultraviolet curable resin coating material forming an upper layer except for a star shaped cutout formed at a prescribed position on the paper surface on the transfer roll surface, and over the same area on the outer peripheral surface of the transfer roll G17 bond manufactured by Konishi Company were coated at normal temperature on the transfer roll to produce after drying a residual solids amount of 5 g/m².

As a transfer embossed layer of ultraviolet curable resin coating material for hologram patterns on the upper layer, 5 g/m² (non-diluted) of an ultraviolet curable resin coating material, FDFC-150 varnish, manufactured by Toyo Ink Company was coated on the transfer roll surface other than the star shaped portion, to which, in the uncured state, the hologram surface of a hologram film manufactured experimentally in-house was closely adhered, and after curing, the star shaped hologram film at a prescribed position was peeled off and the star shaped cutout portion comprised of the ultraviolet curable resin coating material was formed by the hologram transfer embossed layer.

For transfer of matt patterns, there was used PET film No. PO25 manufactured by Toray Company having a film thickness of 12 μm coated on the easy adhesive side with 3 g/m² (non-diluted) of an ultraviolet curable resin coating material, FDFC-150 varnish manufactured by Toyo Ink Company, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

G17 bond manufactured by Konishi Company was coated on the opposite side of the matt pattern transfer film to the matt surface to produce, after drying, a residual solids amount of 8 g/m², and was closely adhered to the hologram surface comprised by the embossed layer of the ultraviolet curable resin coating material for the transfer roll hologram transfer.

Then, the base sheet was paid out from the conveyor roll at a speed of 10 m/min. between the conveyor roll and the transfer roll heated to 100° C. for press contacting while using a heater over the belt conveyor to heat the surface temperature of the base sheet to 40° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Embodiment 7

The following manufacturing was carried out using the apparatus shown in FIGS. 6 to 10.

Step (A):

As the base sheet, OK Topcoat 110 g/m² sheets manufactured by Oji Paper Company were cut in half, and a film (#3162 manufactured by Toyobo Company) having a 4 μm layer of soft polypropylene with a softening temperature of 120° C. and a base 25 μm thick composed of biaxially oriented polypropylene was coated on the opposite surface to the polypropylene coated surface with an adhesive composed of D-Tight 6920 manufactured by DIC Corporation mixed with PL hardener 50 in a ratio of 15:1 using a sheet film laminator manufactured by Matsumoto Kikai Mfg. to produce a residual solids amount after drying of 5 g/m², and was adhered to one side of the above sheets.

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

For a transfer roll, an ultraviolet curable resin coating material forming an upper layer except for a star shaped cutout formed at a prescribed position on the paper surface on the outer peripheral surface, and over the same area on the outer peripheral surface of the transfer roll G17 bond manufactured by Konishi Company were coated at a normal temperature on the transfer roll to produce after drying a residual solids amount of 5 g/m².

As a transfer embossed layer of ultraviolet curable resin coating material for hologram patterns on the upper layer, 3 g/m² (non-diluted) of an ultraviolet curable resin coating material, FDFC-150 varnish, manufactured by Toyo Ink Company was coated on the transfer roll surface other than the star shaped portion, to which, in the uncured state, the hologram surface of a hologram film manufactured experimentally in-house was closely adhered, and after curing, the star shaped hologram film at a prescribed position was peeled off and the star shape cutout portion comprised of the ultraviolet curable resin coating material was formed by the hologram transfer embossed layer.

For transfer of matt patterns, 5 g/m² (non-diluted) of an ultraviolet curable resin coating material, FDFC-150 varnish, manufactured by Toyo Ink Company, was coated in a round shape on the upper layer of the ultraviolet curable resin coating material for a transfer roll shaped hologram pattern, to which, in the uncured state, the matt surface of FOR-M matt film manufactured by Futamura Chemical Company was closely adhered, and after curing, the matt film was peeled off to form a round shaped matt layer comprised of the ultraviolet curable resin coating material.

Then, the base sheet was paid out from the conveyor roll at a speed of 10 m/min. between the conveyor roll and the transfer roll heated to 100° C. for press contacting while using a heater over the belt conveyor to heat the surface temperature of the base sheet to 40° C.

Step (D):

While cooling the base sheet to a surface temperature of 70° C. the base sheet was peeled from the conveyor roll going from the leading edge to the trailing edge.

The result was that after transfer processing of 100 or more base sheets, the same hologram pattern and matt pattern could be transferred to precisely the same position on each base sheet. In more detail, a star shaped mirror finish portion was reproduced in a raised embossed pattern at a prescribed position, and a round matt finish portion was reproduced in a recessed embossed pattern overlaying a prescribed printing portion.

### Comparative Example 1

The following manufacturing was carried out using substantially the same apparatus as the above-described apparatus, except that there was no claw portion on the conveyor roll.

Step (A):

As the base sheet, 26.5 kg Perfect W duodecimo sheets manufactured by Hokuetsu Paper Company were used. These were cut in half and a gravure plate having a plate depth of 100 lines 80 μm was used with a sheet gravure printer manufactured by Hirose Iron Works. The sheets were partially coated at 60 m/min. with thermoplastic resin coating material composed of Aquacoat KP160 varnish manufactured by Toyo Ink Company mixed and diluted with IPA and water at 10:4.2:1.8; the residual solids amount after drying was 3 g/m².

Steps (B)-(C):

For a conveyor roll, a rubber blanket wound in close adhesion around a roll was used; the rubber had a Shore A hardness of 78 measured by a rubber hardness meter manufactured by Tru-Test Company in conformity with DIN (German Industrial Standard) 5305.

As a transfer film for hologram patterns, there was used PET film No. PO25 manufactured by Toray Company having a film thickness of 12 μm coated on the easy adhesive side with 3 g/m² (non-diluted) of an ultraviolet curable resin coating material, FDFC-150 varnish, manufactured by Toyo Ink Company, to which, in the uncured state, the hologram surface of a hologram film manufactured experimentally in-house was closely adhered, and after curing, the hologram film was peeled off and the hologram layer comprised of the ultraviolet curable resin coating material formed by the transfer film was used to form a star shaped cutout at a specific position.

As a transfer film for matt patterns, there was used PET film No. PO25 manufactured by Toray Company having a film thickness of 12 μm coated on the easy adhesive side with 3 g/m² (non-diluted) of an ultraviolet curable resin coating material, FDFC-150 varnish, manufactured by Toyo Ink Company, to which, in the uncured state, the matt surface of FOR-M matt film manufactured by Futamura Chemical Company was closely adhered, and after curing, the matt film was peeled off and the matt layer comprised of the ultraviolet curable resin coating material formed by the transfer film was used to form a round cutout.

For a transfer roll, G17 bond manufactured by Konishi Company was coated on the opposite surface of the above transfer film used for a hologram pattern to produce, after drying, a residual solids amount of 8 g/m², and was closely adhered to the transfer roll at a normal temperature.

G17 bond manufactured by Konishi Company was coated on the opposite side of the matt pattern transfer film to the matt surface to produce, after drying, a residual solid amount of 8 g/m², and was closely adhered to the hologram surface of the transfer roll hologram transfer film.

Then, the base sheet was paid out from the conveyor roll at a speed of 20 m/min. between the conveyor roll and the transfer roll heated to 100° C. at a pressure of 2000 N/cm for press contacting while using a heater over the belt conveyor to heat the surface temperature of the base sheet to 50° C.

Step (D):

While cooling the base sheet to a surface temperature of 70° C. the base sheet was peeled from the conveyor roll going from the leading edge to the trailing edge.

The result was that because the base sheet conveyance timing differed little by little, although at first glance the positions might seem the same, a comparison showed that the hologram patterns and designs were transferred to completely different positions. Embossed patterns were also formed at different positions.

The foregoing has been explained based on the embodiments present invention. However the invention is not limited to these embodiments and may be embodied in any way that does not change the composition described in the claims.

Various printed materials and various film sheets may be applied as the base sheet, and as the decorative processing on the surface thereof, there may be applied various mirror processing, matt processing and hologram processing, or embossing, and thus can be expected to be applied widely to very many products such as for example various publications, including magazines (including covers, bands, inside covers, inside front/back cover, contents page (main text) pages, boxes and supplements and the like), various types of cards (including toys and games), various types of stationery (clear files, underlays, etc.), various types of securities (vouchers, shares, bonds, insurance certificates, bill registers, checkbooks, etc.), various POP materials, various packaging products, and umbrellas and the like. Just a few examples have been cited, and are not limitative, as the applicability can extend to various semi-finished products that are assemblies of various printed materials and various film sheets.

1. A transfer method comprising the steps of:
coating a thermoplastic resin coating material on a base sheet,
supporting and conveying the base sheet coated with the thermoplastic resin coating material by gripping an end of the base sheet with a claw portion provided on a conveyor roll,
providing a step wherein a position of the claw portion on the conveyor roll is sensed and a transfer roll having adhered and affixed to its outer peripheral surface a film to which any of a mirror finish, a matt finish or a hologram finish has been previously applied is press contacted on the conveyor roll under a condition in which the transfer roll is heated to at least a temperature at which the thermoplastic resin coating material melts, and
peeling the base sheet from the transfer roll and cooling.

2. A transfer method according to claim 1, wherein the film to which any of a mirror finish, a matt finish or a hologram finish has been applied is adhered and affixed over all or part of the peripheral surface of the transfer roll, or is adhered and affixed in layers over all or part of the peripheral surface.

3. A transfer method comprising the steps of:
coating a thermoplastic resin coating material on a base sheet,
supporting and conveying the base sheet coated with the thermoplastic resin by an end of the base sheet gripped by a claw portion provided on a conveyor roll,
providing a step wherein a position of the claw portion on the conveyor roll is sensed and a transfer roll having any of a mirror finish, a matt finish or a hologram finish applied previously to its outer peripheral surface by an ultraviolet curable resin coating material is press contacted on the conveyor roll under a condition in which the transfer roll is heated to at least a temperature at which the thermoplastic resin coating material melts, and
peeling the base sheet from the transfer roll and cooling.

4. A transfer method according to claim 3, wherein any of a mirror finish, a matt finish or a hologram finish formed by an ultraviolet curable resin coating material is formed over all or part of the our peripheral surface of the transfer roll, or is formed in layers over all or part of the outer peripheral surface.

5. A transfer method according to claim 1, wherein the thermoplastic resin coating material coated on a base sheet is brought in a preheated state into close contact with the transfer roll.

6. A transfer apparatus comprising:
a mechanism for coating a thermoplastic resin coating material on a base sheet,
a mechanism for supporting and conveying the base sheet coated with the thermoplastic resin coating material by gripping an end of the base sheet with a claw portion provided on a conveyor roll,
a mechanism for sensing a position of the claw portion on the conveyor roll and press contacting on the conveyor roll a transfer roll having adhered and affixed to its peripheral surface a film to which any of a mirror finish, a matt finish or a hologram finish has been previously applied,
a mechanism for heating the transfer roll to at least a temperature at which the thermoplastic resin coating melts,
a mechanism for peeling the base sheet from the transfer roll, and
a mechanism for cooling the base sheet.

7. A transfer apparatus comprising:
a mechanism for coating a thermoplastic resin coating material on a base sheet,
a mechanism for supporting and conveying the base sheet coated with the thermoplastic resin coating material by gripping an end of the base sheet with a claw portion provided on a conveyor roll,
a mechanism for sensing a position of the claw portion of the conveyor roll and press contacting on the conveyor roll a transfer roll having any of a mirror finish, a matt finish or a hologram finish applied previously to its peripheral surface by an ultraviolet curable resin coating material,
a mechanism for heating the transfer roll to at least a temperature at which the thermoplastic resin coating melts,
a mechanism for peeling the base sheet from the transfer roll, and
a mechanism for cooling the base sheet.

8. A sheet product manufactured by a transfer method according to claim 1.
